(19) United States
(12) Patent Application Publication
(10) Pub. No.: US 2023/0324916 A1
(43) Pub. Date: Oct. 12, 2023

(54) Autonomous Robotic Platform

(71) Applicants: Lana Graf, Great Falls, VA (US); Alex Rand, Cambridge, MA (US); Eric J. Cushman, Glastonbury, CT (US); Thomas Freeman Gilbane, Jr., Palm Beach, FL (US)

(72) Inventors: Lana Graf, Great Falls, VA (US); Alex Rand, Cambridge, MA (US); Eric J. Cushman, Glastonbury, CT (US); Thomas Freeman Gilbane, Jr., Palm Beach, FL (US)

(21) Appl. No.: 18/298,048

(22) Filed: Apr. 10, 2023

Related U.S. Application Data
(60) Provisional application No. 63/328,993, filed on Apr. 8, 2022.

(51) Int. Cl. G05D 1/02; G05D 1/00

(52) U.S. Cl. CPC G05D 1/0219; G05D 1/0055; G05D 2201/0202; G05D 1/0278; G05D 1/0238; G05D 1/0088

(57) ABSTRACT

A computer-implemented method, computer program product and computing system for: navigating an autonomous mobile robot (AMR) within a defined space; acquiring sensory information proximate the autonomous mobile robot (AMR); processing the sensory information to determine if an unsafe condition is occurring proximate the autonomous mobile robot (AMR); and effectuating a response if an unsafe condition is occurring proximate the autonomous mobile robot (AMR).

### RELATED APPLICATION(S)

This application claims the benefit of U.S. Provisional Application No. 63/328,993, filed on 8 Apr. 2022, the entire contents of which are incorporated herein by reference.

### TECHNICAL FIELD

This disclosure relates to robots and, more particularly, to autonomous robots.

### BACKGROUND

Autonomous mobile robots (AMRs) are robots that can move around and perform tasks without the need for human guidance or control. The development of autonomous mobile robots has been driven by advances in robotics, artificial intelligence, and computer vision. The concept of autonomous robots has been around for several decades, but it was not until the late 20th century that the technology became advanced enough to make it a reality. In the early days, autonomous robots were limited to industrial applications, such as manufacturing and assembly line tasks.

However, with the advancements in computer processing power and sensors, autonomous robots have become more sophisticated and can now perform a wide range of tasks. Today, AMRs are used in a variety of applications, including warehousing and logistics, agriculture, healthcare, and even in military and defense.

The development of autonomous mobile robots has been driven by the need for more efficient and cost-effective solutions for various tasks. AMRs can operate around the clock, without the need for breaks or rest, making them ideal for repetitive tasks that would otherwise require human intervention.

### Summary of Disclosure

Safety Monitoring

In one implementation, a computer implemented method is executed on a computing device and includes: navigating an autonomous mobile robot (AMR) within a defined space; acquiring sensory information proximate the autonomous mobile robot (AMR); processing the sensory information to determine if an unsafe condition is occurring proximate the autonomous mobile robot (AMR); and effectuating a response if an unsafe condition is occurring proximate the autonomous mobile robot (AMR).

One or more of the following features may be included. The defined space may be a construction site. Navigating an autonomous mobile robot (AMR) within a defined space may include one or more of: navigating the autonomous mobile robot (AMR) within a defined space to effectuate a patrol of the defined space; and navigating the autonomous mobile robot (AMR) within a defined space to visit a plurality of defined locations with the defined space. The plurality of defined locations may include one or more of: at least one human defined location; and at least one machine defined location. Navigating an autonomous mobile robot (AMR) within a defined space may include one or more of: navigating an autonomous mobile robot (AMR) within a defined space via a predefined navigation path; navigating an autonomous mobile robot (AMR) within a defined space via GPS coordinates; and navigating an autonomous mobile robot (AMR) within a defined space via a machine vision system. The machine vision system may include one or more of: a LIDAR system; and a plurality of discrete machine vision cameras. Effectuating a response if an unsafe condition is occurring proximate the autonomous mobile robot (AMR) may include: effectuating an audible response if an unsafe condition is occurring proximate the autonomous mobile robot (AMR). Effectuating a response if an unsafe condition is occurring proximate the autonomous mobile robot (AMR) may include: effectuating a visual response if an unsafe condition is occurring proximate the autonomous mobile robot (AMR). Effectuating a response if an unsafe condition is occurring proximate the autonomous mobile robot (AMR) may include: effectuating a reporting response if an unsafe condition is occurring proximate the autonomous mobile robot (AMR). Effectuating a reporting response if an unsafe condition is occurring proximate the autonomous mobile robot (AMR) may include one or more of: notifying a law enforcement entity; notifying a fire/safety entity; notifying a monitoring entity; notifying a management entity; and notifying a third party.

In another implementation, a computer program product resides on a computer readable medium and has a plurality of instructions stored on it. When executed by a processor, the instructions cause the processor to perform operations including: navigating an autonomous mobile robot (AMR) within a defined space; acquiring sensory information proximate the autonomous mobile robot (AMR); processing the sensory information to determine if an unsafe condition is occurring proximate the autonomous mobile robot (AMR); and effectuating a response if an unsafe condition is occurring proximate the autonomous mobile robot (AMR).

One or more of the following features may be included. The defined space may be a construction site. Navigating an autonomous mobile robot (AMR) within a defined space may include one or more of: navigating the autonomous mobile robot (AMR) within a defined space to effectuate a patrol of the defined space; and navigating the autonomous mobile robot (AMR) within a defined space to visit a plurality of defined locations with the defined space. The plurality of defined locations may include one or more of: at least one human defined location; and at least one machine defined location. Navigating an autonomous mobile robot (AMR) within a defined space may include one or more of: navigating an autonomous mobile robot (AMR) within a defined space via a predefined navigation path; navigating an autonomous mobile robot (AMR) within a defined space via GPS coordinates; and navigating an autonomous mobile robot (AMR) within a defined space via a machine vision system. The machine vision system may include one or more of: a LIDAR system; and a plurality of discrete machine vision cameras. Effectuating a response if an unsafe condition is occurring proximate the autonomous mobile robot (AMR) may include: effectuating an audible response if an unsafe condition is occurring proximate the autonomous mobile robot (AMR). Effectuating a response if an unsafe condition is occurring proximate the autonomous mobile robot (AMR) may include: effectuating a visual response if an unsafe condition is occurring proximate the autonomous mobile robot (AMR). Effectuating a response if an unsafe condition is occurring proximate the autonomous mobile robot (AMR) may include: effectuating a reporting response if an unsafe condition is occurring proximate the autonomous mobile robot (AMR). Effectuating a reporting response if an unsafe condition is occurring proximate the autonomous mobile robot (AMR) may include one or more of: notifying a law enforcement entity; notifying a fire/safety entity; notifying a monitoring entity; notifying a management entity; and notifying a third party.

In another implementation, a computing system includes a processor and a memory system configured to perform operations including: navigating an autonomous mobile robot (AMR) within a defined space; acquiring sensory information proximate the autonomous mobile robot (AMR); processing the sensory information to determine if an unsafe condition is occurring proximate the autonomous mobile robot (AMR); and effectuating a response if an unsafe condition is occurring proximate the autonomous mobile robot (AMR).

One or more of the following features may be included. The defined space may be a construction site. Navigating an autonomous mobile robot (AMR) within a defined space may include one or more of: navigating the autonomous mobile robot (AMR) within a defined space to effectuate a patrol of the defined space; and navigating the autonomous mobile robot (AMR) within a defined space to visit a plurality of defined locations with the defined space. The plurality of defined locations may include one or more of: at least one human defined location; and at least one machine defined location. Navigating an autonomous mobile robot (AMR) within a defined space may include one or more of: navigating an autonomous mobile robot (AMR) within a defined space via a predefined navigation path; navigating an autonomous mobile robot (AMR) within a defined space via GPS coordinates; and navigating an autonomous mobile robot (AMR) within a defined space via a machine vision system. The machine vision system may include one or more of: a LIDAR system; and a plurality of discrete machine vision cameras. Effectuating a response if an unsafe condition is occurring proximate the autonomous mobile robot (AMR) may include: effectuating an audible response if an unsafe condition is occurring proximate the autonomous mobile robot (AMR). Effectuating a response if an unsafe condition is occurring proximate the autonomous mobile robot (AMR) may include: effectuating a visual response if an unsafe condition is occurring proximate the autonomous mobile robot (AMR). Effectuating a response if an unsafe condition is occurring proximate the autonomous mobile robot (AMR) may include: effectuating a reporting response if an unsafe condition is occurring proximate the autonomous mobile robot (AMR). Effectuating a reporting response if an unsafe condition is occurring proximate the autonomous mobile robot (AMR) may include one or more of: notifying a law enforcement entity; notifying a fire/safety entity; notifying a monitoring entity; notifying a management entity; and notifying a third party.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an autonomous mobile robot process according to an embodiment of the present disclosure;

FIGS. 2A-2D are isometric views of an autonomous mobile robot (AMR) system that is controllable by the autonomous mobile robot process of FIG. 1 according to an embodiment of the present disclosure;

FIG. 3 is a flowchart of one embodiment of the autonomous mobile robot process of FIG. 1 according to an embodiment of the present disclosure;

FIG. 4 is a diagrammatic view of a navigation path for the autonomous mobile robot (AMR) system of FIG. 2 according to an embodiment of the present disclosure;

FIG. 5 is a diagrammatic view of a user interface rendered by the autonomous mobile robot process of FIG. 1 according to an embodiment of the present disclosure;

FIG. 6 is a flowchart of another embodiment of the autonomous mobile robot process of FIG. 1 according to an embodiment of the present disclosure;

FIG. 7 is a flowchart of another embodiment of the autonomous mobile robot process of FIG. 1 according to an embodiment of the present disclosure; and

FIG. 8 is a flowchart of another embodiment of the autonomous mobile robot process of FIG. 1 according to an embodiment of the present disclosure.

Like reference symbols in the various drawings indicate like elements.

### DETAILED DESCRIPTION OF THE PREFERRED EMBODIMENTS

Autonomous Mobile Robot Process

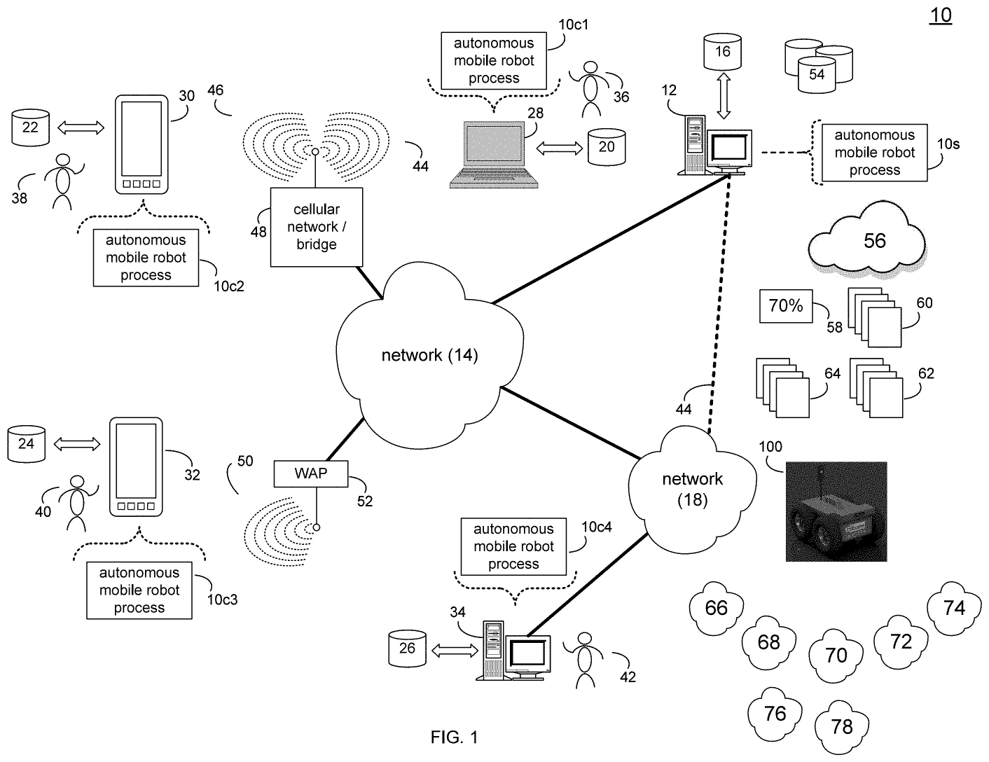

Referring to FIG. 1, there is shown autonomous mobile robot process 10 that is configured to interact with autonomous mobile robot (AMR) system 100.

Autonomous mobile robot process 10 may be implemented as a server-side process, a client-side process, or a hybrid server-side/client-side process. For example, autonomous mobile robot process 10 may be implemented as a purely server-side process via autonomous mobile robot process 10s. Alternatively, autonomous mobile robot process 10 may be implemented as a purely client-side process via one or more of autonomous mobile robot process 10c1, autonomous mobile robot process 10c2, autonomous mobile robot process 10c3, and autonomous mobile robot process 10c4. Alternatively still, autonomous mobile robot process 10 may be implemented as a hybrid server-side/client-side process via autonomous mobile robot process 10s in combination with one or more of autonomous mobile robot process 10c1, autonomous mobile robot process 10c2, autonomous mobile robot process 10c3, and autonomous mobile robot process 10c4. Accordingly, autonomous mobile robot process 10 as used in this disclosure may include any combination of autonomous mobile robot process 10s, autonomous mobile robot process 10c1, autonomous mobile robot process 10c2, autonomous mobile robot process 10c3, and autonomous mobile robot process 10c4.

Autonomous mobile robot process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of autonomous mobile robot process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random-access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of autonomous mobile robot processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of autonomous mobile robot processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to a personal digital assistant (not shown), a tablet computer (not shown), laptop computer 28, smart phone 30, smart phone 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™ Android™, iOS™, Linux™, or a custom operating system.

Users 36, 38, 40, 42 may access autonomous mobile robot process 10 directly through network 14 or through secondary network 18. Further, autonomous mobile robot process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and smart phone 30 are shown wirelessly coupled to network 14 via wireless communication channels 44, 46 (respectively) established between laptop computer 28, smart phone 30 (respectively) and cellular network/bridge 48, which is shown directly coupled to network 14. Further, smart phone 32 is shown wirelessly coupled to network 14 via wireless communication channel 50 established between smart phone 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between smart phone 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Autonomous Mobile Robot System

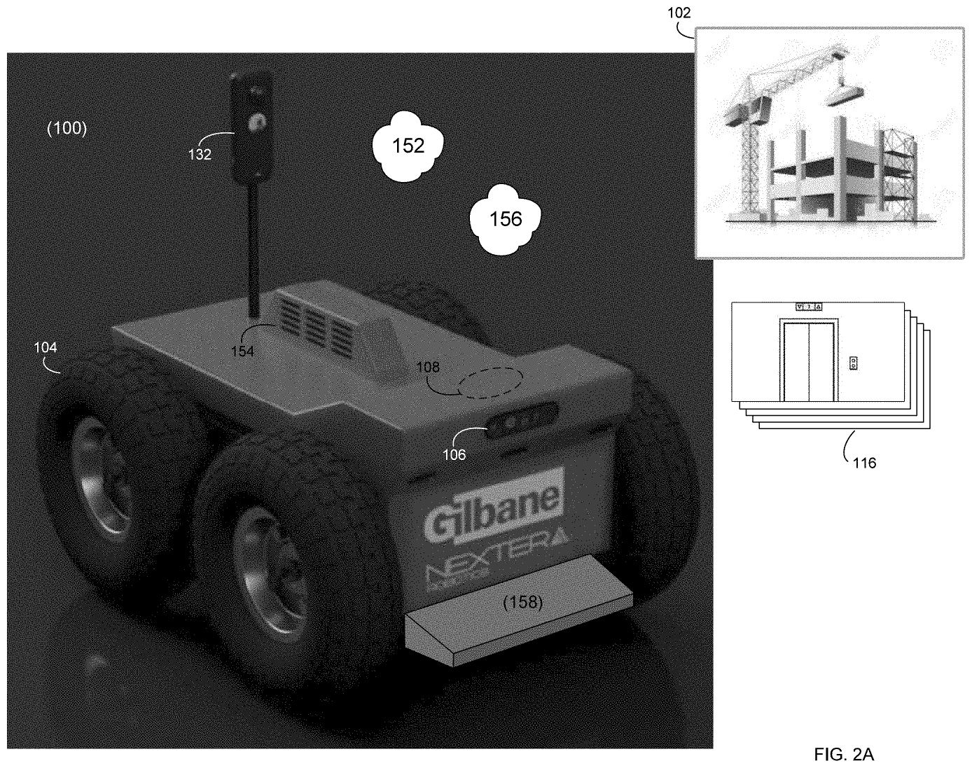

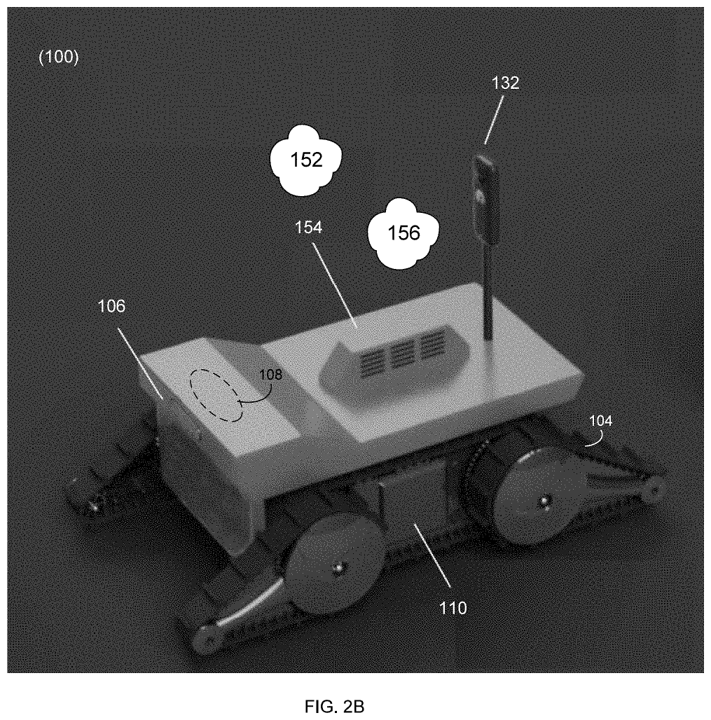

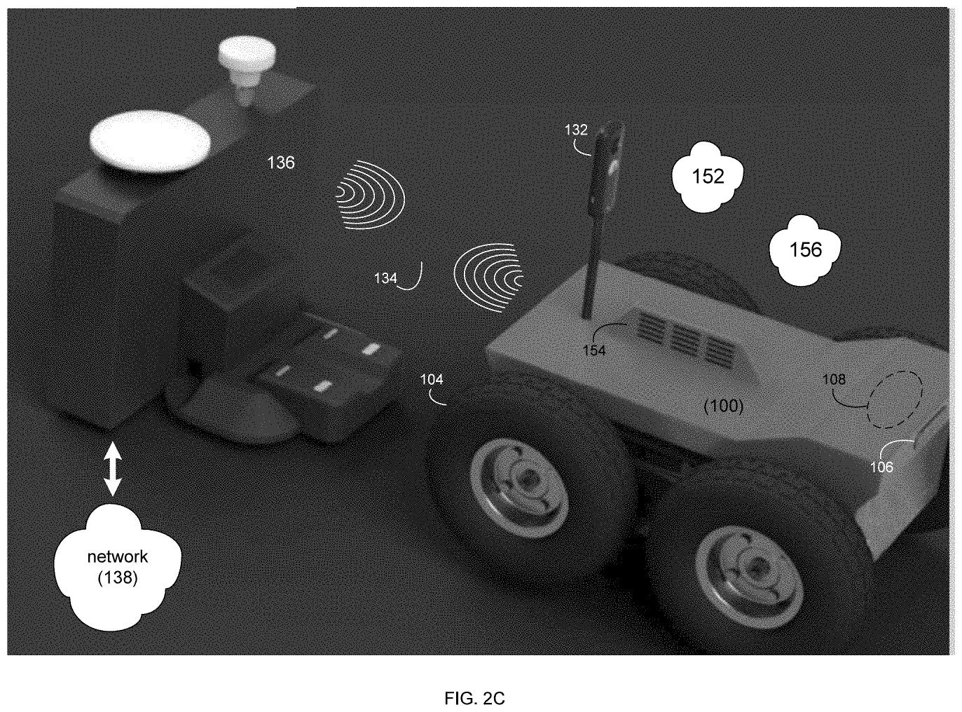

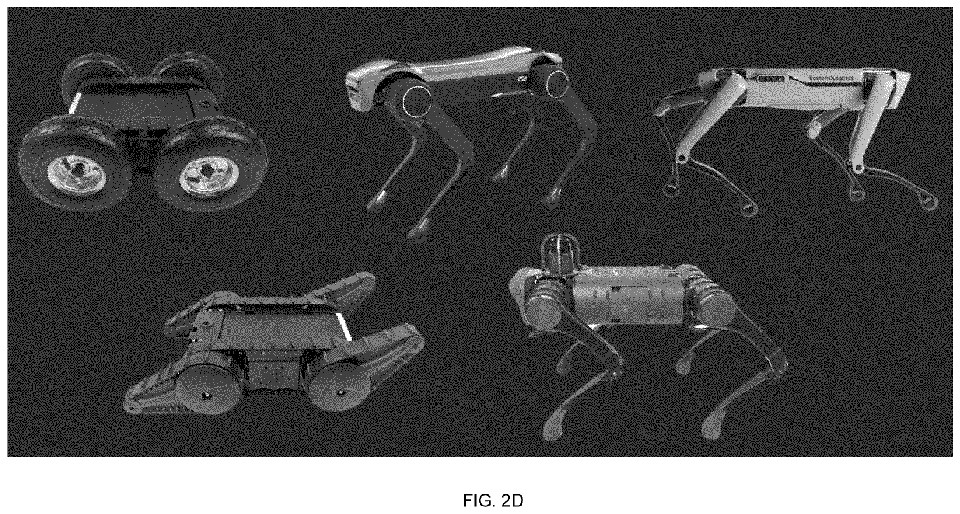

Referring also to FIG. 2A-2D, there is shown autonomous mobile robot (AMR) system 100 that may be configured to navigate within a defined space (e.g., defined space 102). As is known in the art, an autonomous mobile robot (AMR) is a type of robot that can move independently and make decisions on its own without human intervention. These AMRs are equipped with various sensors such as cameras, lidar, ultrasonic sensors, and others that allow them to perceive their environment and make decisions based on the data they collect.

The key components of an AMR may include a mobile base (e.g., mobile base 104), a navigation subsystem (e.g., navigation subsystem 106), a controller subsystem (e.g., controller subsystem 108), and a power source (e.g., battery 110). The mobile base (e.g., mobile base 104) may be a wheeled or tracked platform, or it may use legs to move like a quadruped robot. The sensors (e.g., navigation subsystem 106) may provide information about the robot's surroundings, such as obstacles, people, or other objects. The controller (e.g., controller subsystem 108) may process this information and generate commands for the robot's actuators to move and interact with the environment.

Visual Documentation

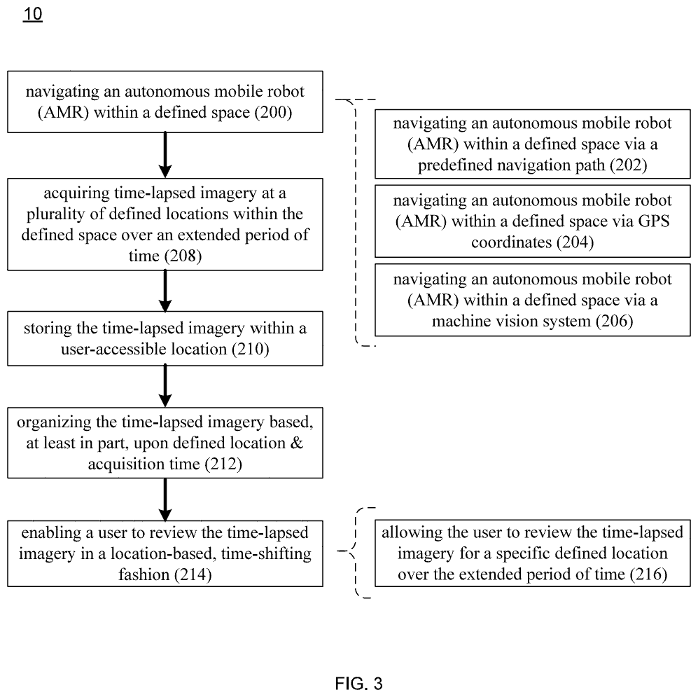

Referring also to FIG. 3 and as will be discussed below in greater detail, autonomous mobile robot process 10 may enable autonomous mobile robot (AMR) 100 to perform visual documentation functionality within a defined space (e.g., defined space 102).

Autonomous mobile robot process 10 may navigate 200 an autonomous mobile robot (AMR) 100 within a defined space (e.g., defined space 102). An example of this defined space (e.g., defined space 102) may include but is not limited to a construction site.

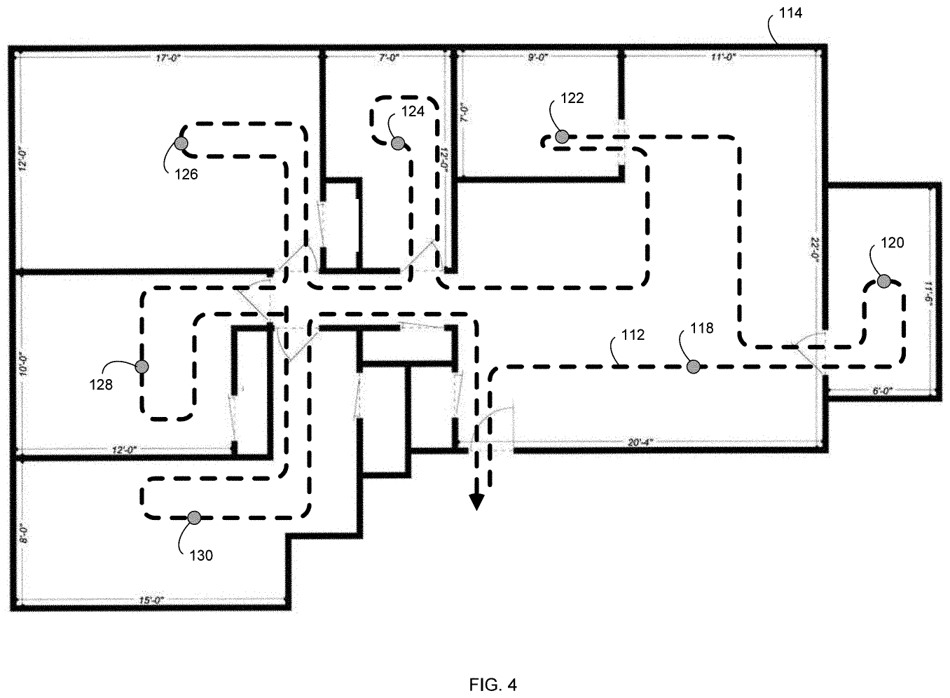

Referring also to FIG. 4, when navigating 200 an autonomous mobile robot (AMR) 100 within a defined space (e.g., defined space 102), autonomous mobile robot process 10 may:
navigate 202 an autonomous mobile robot (AMR) 100 within a defined space (e.g., defined space 102) via a predefined navigation path. For example, a predefined navigation path (e.g., predefined navigation path 112) may be defined (e.g., via GPS coordinates or some other means) within a floor plan (e.g., floor plan 114) of defined space 102 along which autonomous mobile robot process 10 may navigate autonomous mobile robot (AMR) 100.
navigate 204 an autonomous mobile robot (AMR) 100 within a defined space (e.g., defined space 102) via GPS coordinates. For example, controller subsystem 108 within autonomous mobile robot (AMR) 100 (or any other portion thereof) may include a GPS system (not shown) to enable autonomous mobile robot (AMR) 100 to navigate within defined space 102 via a sequence of GPS-based waypoints that may be sequentially navigated to in order to effectuate navigation of predefined navigation path 112.
navigate 206 an autonomous mobile robot (AMR) 100 within a defined space (e.g., defined space 102) via a machine vision system (e.g., navigation subsystem 106). The machine vision system (e.g., navigation subsystem 106) may include various components/systems, examples of which may include but are not limited to: a LIDAR system; a RADAR system, one or more discrete machine vision cameras, one or more thermal imaging cameras, one or more laser range finders, etc.

To operate autonomously, autonomous mobile robot (AMR) 100 may use various algorithms such as simultaneous localization and mapping (SLAM) to create a map of the environment and localize themselves within it. Autonomous mobile robot (AMR) 100 may also use path planning algorithms to find the best route to navigate through the environment, avoiding obstacles and other hazards.

As is known in the art, Simultaneous Localization and Mapping (SLAM) is a computational technique used by AMRs to map and navigate an unknown environment (e.g., defined space 102). SLAM works by using sensor data, such as laser range finders, cameras, or other sensors, to gather information about the AMRs' environment. The AMR may use this data to create a map (e.g., floor plan 114) of its surroundings while also estimating its own location within the map (e.g., floor plan 114). The process is called “simultaneous” because the AMR is building the map (e.g., floor plan 114) and localizing itself at the same time.

The SLAM algorithm involves several steps, including data acquisition, feature extraction, data association, and estimation. In the data acquisition step, the AMR collects sensor data about its environment. In the feature extraction step, the algorithm extracts key features from the data, such as edges or corners in the environment. In the data association step, the algorithm matches the features in the current sensor data to those in the existing map. Finally, in the estimation step, the algorithm uses statistical methods to estimate the robot's position in the map.

SLAM is a critical technology for many applications, such as autonomous vehicles, mobile robots, and drones, as it enables these devices to operate in unknown and dynamic environments and navigate safely and efficiently. AMRs may be used in a wide range of applications, including manufacturing, logistics, healthcare, agriculture, and security, wherein these AMRs may perform a variety of tasks such as transporting materials, delivering goods, cleaning, and inspection. With advances in artificial intelligence and machine learning, AMRs are becoming more sophisticated and capable of handling more complex tasks.

Autonomous mobile robot process 10 may acquire 208 time-lapsed imagery (e.g., imagery 116) at a plurality of defined locations (e.g., locations 118, 120, 122, 124, 126, 128, 130) within the defined space (e.g., defined space 102) over an extended period of time. Examples of such time-lapsed imagery may include but are not limited to:
flat images: images that portray information in two dimensions, such as traditional photographs and print images.
360° images: images that are more immersive than flat images, in that they have a three-dimensional component that allows the viewer to pivot/rotate the images as if they were moving their head to look around an area.
videos: a series of still images coupled together to form that perception of flowing movement of the image.

The time-lapsed imagery (e.g., imagery 116) may be collected via a vision system (e.g., vision system 132) mounted upon/included within/coupled to autonomous mobile robot (AMR) 100. Vision system 132 may include one or more discrete camera assemblies that may be used to acquire 208 the time-lapsed imagery (e.g., imagery 116).

The time-lapsed imagery (e.g., imagery 116) may be collected on a regular/recurring basis. For example, autonomous mobile robot process 10 may acquire 208 an image from each of the plurality of defined locations (e.g., locations 118, 120, 122, 124, 126, 128, 130) within the defined space (e.g., defined space 102) at regular intervals (e.g., every day, every week, every month, every quarter) over an extended period of time (e.g., the life of a construction project).

The plurality of defined locations (e.g., locations 118, 120, 122, 124, 126, 128, 130) may include one or more of: at least one human defined location; and at least one machine defined location. For example, one or more administrators/operators (e.g., one or more of users 36, 38, 40, 42) of autonomous mobile robot process 10 may define the plurality of defined locations (e.g., locations 118, 120, 122, 124, 126, 128, 130) using GPS coordinates to which autonomous mobile robot (AMR) 100 may navigate. Additionally/alternatively, autonomous mobile robot process 10 and/or autonomous mobile robot (AMR) 100 may define the plurality of defined locations (e.g., locations 118, 120, 122, 124, 126, 128, 130) along (in this example) predefined navigation path 112, wherein the plurality of defined locations (e.g., locations 118, 120, 122, 124, 126, 128, 130) are defined to e.g., be spaced every 50 feet to provide overlapping visual coverage or located based upon some selection criteria (e.g., larger spaces, smaller spaces, more complex spaces as defined within a building plan, more utilized spaces as defined within a building plan).

As is known in the art, GPS (i.e., Global Positioning System) is a satellite-based navigation system that allows users to determine their precise location on Earth, which uses a network of satellites, ground-based control stations, and receivers to provide accurate positioning, navigation, and timing information.

Generally speaking, GPS satellites are positioned in orbit around the Earth. The GPS constellation typically consists of 24 operational satellites, arranged in six orbital planes, with four satellites in each plane. These satellites are constantly transmitting signals that carry information about their location and the time the signal was transmitted. GPS receivers are devices that users carry or are installed on vehicles, smartphones, or other devices, wherein these GPS receivers receive signals from multiple GPS satellites overhead. Once the GPS receiver receives signals from at least four GPS satellites, the GPS receiver uses a process called trilateration to determine the user's precise location. Trilateration involves measuring the time it takes for the signals to travel from the satellites to the receiver and using that information to calculate the distance between the receiver and each satellite. Using the distances calculated through trilateration, the GPS receiver may determine the user's precise location by finding the point where the circles (or spheres in three-dimensional space) representing the distances from each satellite intersect. This point represents the user's position on Earth. Once the user's position is determined, GPS may be used for navigation by calculating the user's direction, speed, and time to reach a desired destination based on their position and movement.

Autonomous mobile robot process 10 may store 210 the time-lapsed imagery (e.g., imagery 116) within a user-accessible location (e.g., image repository 54). An example of image repository 54 includes any data storage structure that enables the storage/access/distribution of the time-lapsed imagery (e.g., imagery 116) for one or more user (e.g., one or more of users 36, 38, 40, 42) of autonomous mobile robot process 10.

When storing 210 the time-lapsed imagery (e.g., imagery 116) within a user-accessible location (e.g., image repository 54), autonomous mobile robot process 10 may wirelessly upload time-lapsed imagery (e.g., imagery 116) to the user-accessible location (e.g., image repository 54) via e.g., a wireless communication channel (e.g., wireless communication channel 134) established between autonomous mobile robot (AMR) 100 and docking station 136, wherein docking station 136 may be coupled to network 138 to enable communication with the user-accessible location (e.g., image repository 54). Additionally/alternatively, autonomous mobile robot (AMR) 100 may upload time-lapsed imagery (e.g., imagery 116) to the user-accessible location (e.g., image repository 54) via a wired connection between autonomous mobile robot (AMR) 100 and docking station 136 that is established when autonomous mobile robot (AMR) 100 is e.g., docked for charging purposes.

Autonomous mobile robot process 10 may organize 212 the time-lapsed imagery (e.g., imagery 116) within a user-accessible location (e.g., image repository 54) based, at least in part, upon defined location & acquisition time of the images within time-lapsed imagery (e.g., imagery 116). Accordingly:
all images included within the time-lapsed imagery (e.g., imagery 116) that were acquired 208 by autonomous mobile robot (AMR) 100 at location 118 may be grouped within image repository 54 and organized/timestamped (e.g., via metadata) in a time-dependent fashion (e.g., oldest→newest; newest→oldest, etc.);
all images included within the time-lapsed imagery (e.g., imagery 116) that were acquired 208 by autonomous mobile robot (AMR) 100 at location 120 may be grouped within image repository 54 and organized/timestamped (e.g., via metadata) in a time-dependent fashion (e.g., oldest→newest; newest→oldest, etc.);
all images included within the time-lapsed imagery (e.g., imagery 116) that were acquired 208 by autonomous mobile robot (AMR) 100 at location 122 may be grouped within image repository 54 and organized/timestamped (e.g., via metadata) in a time-dependent fashion (e.g., oldest→newest; newest→oldest, etc.);
all images included within the time-lapsed imagery (e.g., imagery 116) that were acquired 208 by autonomous mobile robot (AMR) 100 at location 124 may be grouped within image repository 54 and organized/timestamped (e.g., via metadata) in a time-dependent fashion (e.g., oldest→newest; newest→oldest, etc.);
all images included within the time-lapsed imagery (e.g., imagery 116) that were acquired 208 by autonomous mobile robot (AMR) 100 at location 126 may be grouped within image repository 54 and organized/timestamped (e.g., via metadata) in a time-dependent fashion (e.g., oldest→newest; newest→oldest, etc.);
all images included within the time-lapsed imagery (e.g., imagery 116) that were acquired 208 by autonomous mobile robot (AMR) 100 at location 128 may be grouped within image repository 54 and organized/timestamped (e.g., via metadata) in a time-dependent fashion (e.g., oldest→newest; newest→oldest, etc.); and
all images included within the time-lapsed imagery (e.g., imagery 116) that were acquired 208 by autonomous mobile robot (AMR) 100 at location 130 may be grouped within image repository 54 and organized/timestamped (e.g., via metadata) in a time-dependent fashion (e.g., oldest→newest; newest→oldest, etc.).

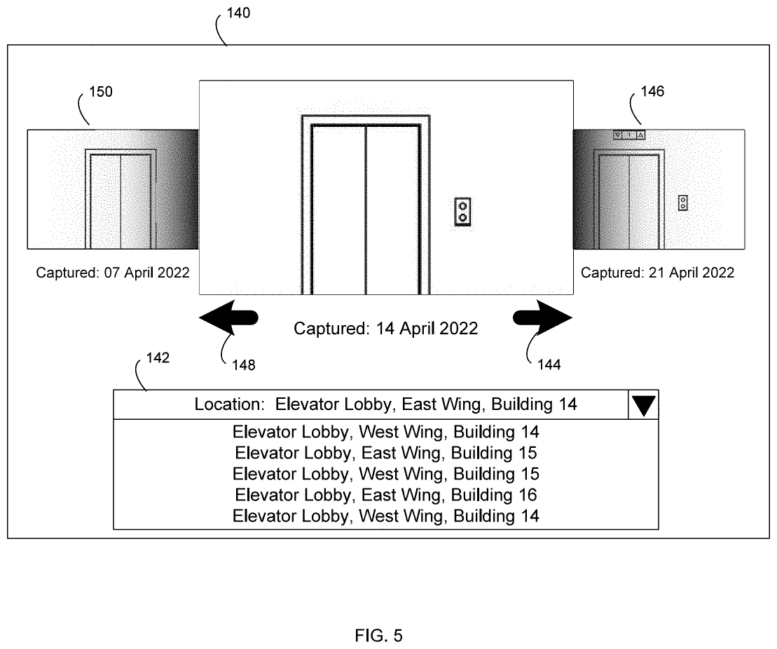

Referring also to FIG. 5, autonomous mobile robot process 10 may enable 214 a user (e.g., one or more of users 36, 38, 40, 42) to review the time-lapsed imagery (e.g., imagery 116) in a location-based, time-shifting fashion. When enabling 214 a user (e.g., one or more of users 36, 38, 40, 42) to review the time-lapsed imagery (e.g., imagery 116) in a location-based, time-shifting fashion, autonomous mobile robot process 10 may allow 216 the user (e.g., one or more of users 36, 38, 40, 42) to review the time-lapsed imagery (e.g., imagery 116) for a specific defined location over the extended period of time.

For example, assume that autonomous mobile robot process 10 gathers one image per week (for a year) for each of the plurality of defined locations (e.g., locations 118, 120, 122, 124, 126, 128, 130) that are stored 210 on image repository 54. Accordingly, autonomous mobile robot process 10 may render user interface 140 that allows the user (e.g., one or more of users 36, 38, 40, 42) to select a specific location (from plurality of locations 118, 120, 122, 124, 126, 128, 130) via e.g., drop down menu 142. Assume for this example that the user (e.g., one or more of users 36, 38, 40, 42) selects “Elevator Lobby, East Wing, Building 14”. Accordingly, autonomous mobile robot process 10 may retrieve from image repository 54 the images included within the time-lapsed imagery (e.g., imagery 116) that are associated with the location “Elevator Lobby, East Wing, Building 14”.

As autonomous mobile robot process 10 gathered one image per week (for a year) for each of the plurality of defined locations (e.g., locations 118, 120, 122, 124, 126, 128, 130), autonomous mobile robot process 10 may retrieve fifty-two images from time-lapsed imagery (e.g., imagery 116) that are associated with the location “Elevator Lobby, East Wing, Building 14”. These fifty-two images may be presented to the user (e.g., one or more of users 36, 38, 40, 42) in a time sequenced fashion that allows 216 the user (e.g., one or more of users 36, 38, 40, 42) to review the time-lapsed imagery (e.g., imagery 116) for a specific defined location over the extended period of time. For example, the user (e.g., one or more of users 36, 38, 40, 42) may select forward button 144 to view the next image (e.g., image 146) in the temporal sequence of the images associated with the location “Elevator Lobby, East Wing, Building 14” and/or select backwards button 148 to view to the previous image (e.g., image 150) in the temporal sequence of the images associated with location “Elevator Lobby, East Wing, Building 14”.

Accordingly and through the use of autonomous mobile robot process 10, the user (e.g., one or more of users 36, 38, 40, 42) may visually “go back in time” and e.g., remove drywall, remove plumbing systems, remove electrical system, etc. to see areas that are no longer visible in a completed construction project, thus allowing e.g., the locating of a hidden standpipe, the location of a hidden piece of ductwork, etc.

Progress Tracking

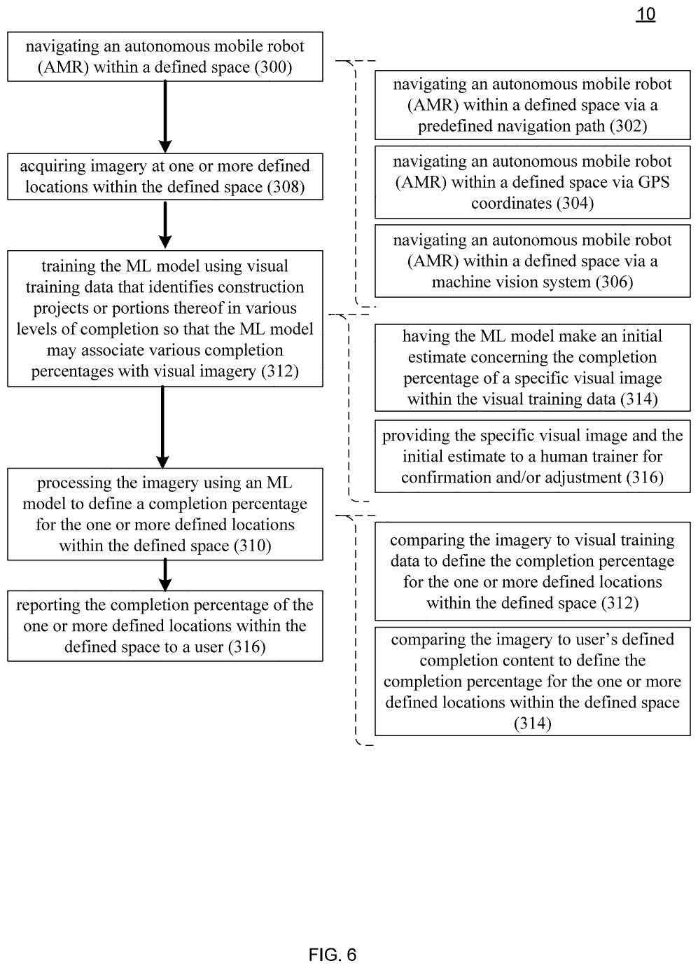

Referring also to FIG. 6 and as will be discussed below in greater detail, autonomous mobile robot process 10 may enable autonomous mobile robot (AMR) 100 to perform progress tracking functionality within a defined space (e.g., defined space 102).

As discussed above, autonomous mobile robot process 10 may navigate 300 an autonomous mobile robot (AMR) 100 within a defined space (e.g., defined space 102), an example of which may include but is not limited to a construction site. As also discussed above, when navigating 300 an autonomous mobile robot (AMR) 100 within a defined space (e.g., defined space 102), autonomous mobile robot process 10 may:
navigate 302 an autonomous mobile robot (AMR) 100 within a defined space (e.g., defined space 102) via a predefined navigation path (e.g., predefined navigation path 112);
navigate 304 an autonomous mobile robot (AMR) 100 within a defined space (e.g., defined space 102) via GPS coordinates; and/or navigate 306 an autonomous mobile robot (AMR) 100 within a defined space (e.g., defined space 102) via a machine vision system (e.g., navigation subsystem 106), which may include various components/systems such as: a LIDAR system; a RADAR system, one or more discrete machine vision cameras, one or more thermal imaging cameras, one or more laser range finders, etc.

As discussed above, autonomous mobile robot process 10 may acquire 308 imagery (e.g., imagery 116) at one or more defined locations (e.g., locations 118, 120, 122, 124, 126, 128, 130) within the defined space (e.g., defined space 102). Examples of such imagery may include but are not limited to:
flat images: images that portray information in two dimensions, such as traditional photographs and print images.
360° images: images that are more immersive than flat images, in that they have a three-dimensional component that allows the viewer to pivot/rotate the images as if they were moving their head to look around an area.
videos: a series of still images coupled together to form that perception of flowing movement of the image.

As discussed above, the plurality of defined locations (e.g., locations 118, 120, 122, 124, 126, 128, 130) may include at least one human defined location and/or at least one machine defined location. As also discussed above, autonomous mobile robot process 10 may store the imagery (e.g., imagery 116) within image repository 54.

Autonomous mobile robot process 10 may process 310 the imagery (e.g., imagery 116) using an ML model (e.g., ML model 56) to define a completion percentage (e.g., completion percentage 58) for the one or more defined locations (e.g., locations 118, 120, 122, 124, 126, 128, 130) within the defined space (e.g., defined space 102).

As is known in the art, ML models may be utilized to process images (e.g., imagery 116). Specifically, ML models (e.g., ML model 56) may process training data (e.g., visual training data 60) so that the ML model (e.g., ML model 56) may be used to process the imagery (e.g., imagery 116) stored within image repository 54. Specifically and with respect to training the ML model (e.g., ML model 56), several processes may be performed as follows:
Data Collection: Images may be collected as a dataset (e.g., visual training data 60), which serves as the input for the machine learning model (e.g., ML model 56). This dataset (e.g., visual training data 60) may be obtained from various sources, such as online image databases or custom image collections.
Data Preprocessing: The collected images (e.g., visual training data 60) may be preprocessed to prepare them for input into the machine learning model (e.g., ML model 56). This may involve resizing, normalizing pixel values, converting to grayscale, or augmenting the dataset (e.g., visual training data 60) with additional images to increase diversity and improve model performance.
Feature Extraction: Machine learning models (e.g., ML model 56) typically require input in the form of numerical features. Therefore, images (e.g., visual training data 60) may need to be converted into a format that can be interpreted by the model (e.g., ML model 56). This process may involve extracting relevant features from the images (e.g., visual training data 60), such as edges, corners, or textures, using techniques like convolutional neural networks (CNNs) or handcrafted feature extraction methods.
Model Training: Once the images (e.g., visual training data 60) are preprocessed and converted into numerical features, the machine learning model (e.g., ML model 56) may be trained on the dataset (e.g., visual training data 60). During training, the model (e.g., ML model 56) may learn the underlying patterns and relationships between the input images (e.g., visual training data 60) and their corresponding labels or targets. This may involve adjusting the model's parameters to minimize the prediction error, typically using techniques like gradient descent.
Model Evaluation: After the model (e.g., ML model 56) is trained using visual training data 60, ML model 56 may be evaluated on a separate dataset (e.g., testing dataset 62) to assess the performance of ML model 56. This evaluation may involve metrics such as accuracy, precision, recall, or F1 score, depending on the specific task the model (e.g., ML model 56) is designed to perform.
Model Prediction: Once the model (e.g., ML model 56) is trained (e.g., using visual training data 60) and evaluated (e.g., using testing dataset 62), ML model 56 may be used for making predictions on new, unseen images (e.g., imagery 116). The preprocessed images (e.g., imagery 116) are input into the trained model (e.g., ML model 56), and the model (e.g., ML model 56) may generate predictions or classifications based on the learned patterns during training.
Post-Processing: The output of the model (e.g., ML model 56) may be post-processed to obtain the desired results. For example, if the task is image classification, the model's predicted class may be converted into a human-readable label (e.g., completion percentage 58). Additionally, post-processing may involve additional steps such as thresholding, filtering, or morphological operations to further refine the predicted results.

Specifically and with respect to the training of ML model 56, autonomous mobile robot process 10 may train 312 the ML model (e.g., ML model 56) using visual training data (e.g., visual training data 60) that identifies construction projects or portions thereof in various levels of completion so that the ML model (e.g., ML model 56) may associate various completion percentage (e.g., completion percentage 58) with visual imagery. For example, assume that visual training data 60 includes 110,000 discrete images, wherein:
10,000 discrete images illustrate various construction projects that are 0% complete, wherein this 0% completion level is defined within associated labels or targets;
10,000 discrete images illustrate various construction projects that are 10% complete, wherein this 10% completion level is defined within associated labels or targets;
10,000 discrete images illustrate various construction projects that are 20% complete, wherein this 20% completion level is defined within associated labels or targets;
10,000 discrete images illustrate various construction projects that are 30% complete, wherein this 30% completion level is defined within associated labels or targets;
10,000 discrete images illustrate various construction projects that are 40% complete, wherein this 40% completion level is defined within associated labels or targets;
10,000 discrete images illustrate various construction projects that are 50% complete, wherein this 50% completion level is defined within associated labels or targets;
10,000 discrete images illustrate various construction projects that are 60% complete, wherein this 60% completion level is defined within associated labels or targets;
10,000 discrete images illustrate various construction projects that are 70% complete, wherein this 70% completion level is defined within associated labels or targets;
10,000 discrete images illustrate various construction projects that are 80% complete, wherein this 80% completion level is defined within associated labels or targets;
10,000 discrete images illustrate various construction projects that are 90% complete, wherein this 90% completion level is defined within associated labels or targets; and
10,000 discrete images illustrate various construction projects that are 100% complete, wherein this 100% completion level is defined within associated labels or targets.

Accordingly and when training 312 the ML model (e.g., ML model 56) using visual training data (e.g., visual training data 60) that identifies construction projects or portions thereof in various percentages of completion, autonomous mobile robot process 10 may:
have 314 the ML model (e.g., ML model 56) make an initial estimate concerning the completion percentage (e.g., completion percentage 58) of a specific visual image within the visual training data (e.g., visual training data 60); and
provide 316 the specific visual image and the initial estimate to a human trainer (e.g., one or more of users 36, 38, 40, 42) for confirmation and/or adjustment.

For example, if ML model 56 applies a completion percentage of 60% to a discrete image (i.e., the initial estimate), autonomous mobile robot process 10 may provide 316 this specific visual image and the initial estimate (60%) to a human trainer (e.g., one or more of users 36, 38, 40, 42) for confirmation and/or adjustment (e.g., confirming 60%, lowering 60% to 50% or raising 70% to 80%).

As discussed above, autonomous mobile robot process 10 may process 310 the imagery (e.g., imagery 116) using the (now trained) ML model (e.g., ML model 56) to define a completion percentage (e.g., completion percentage 58) for the one or more defined locations (e.g., locations 118, 120, 122, 124, 126, 128, 130) within the defined space (e.g., defined space 102).

When processing 310 the imagery (e.g., imagery 116) using an ML model (e.g., ML model 56) to define a completion percentage (e.g., completion percentage 58) for the one or more defined locations (e.g., locations 118, 120, 122, 124, 126, 128, 130) within the defined space (e.g., defined space 102), autonomous mobile robot process 10 may:
compare 312 the imagery (e.g., imagery 116) to visual training data (e.g., visual training data 60) to define the completion percentage (e.g., completion percentage 58) for the one or more defined locations (e.g., locations 118, 120, 122, 124, 126, 128, 130) within the defined space (e.g., defined space 102); and/or
compare 314 the imagery (e.g., imagery 116) to user's defined completion content (e.g., defined completion content 64) to define the completion percentage (e.g., completion percentage 58) for the one or more defined locations (e.g., locations 118, 120, 122, 124, 126, 128, 130) within the defined space (e.g., defined space 102).

An example of defined completion content 64 may include but is not limited to CAD drawings (e.g., internal/external elevations) that show the construction project are various stages of completion (e.g., 0%, 10%, 20%, 30%, 40%, 50%, 60%, 70%, 80%, 90%, 100%). Defined completion content 64 may then be processed by autonomous mobile robot process 10/ML model 56 in a fashion similar to the manner in which visual training data 60 was processed so that ML model 56 may “learn” what these various stages of completion look like.

Autonomous mobile robot process 10 may report 316 the completion percentage (e.g., completion percentage 58) of the one or more defined locations (e.g., locations 118, 120, 122, 124, 126, 128, 130) within the defined space (e.g., defined space 102) to a user (e.g., one or more of users 36, 38, 40, 42).

Safety Monitoring

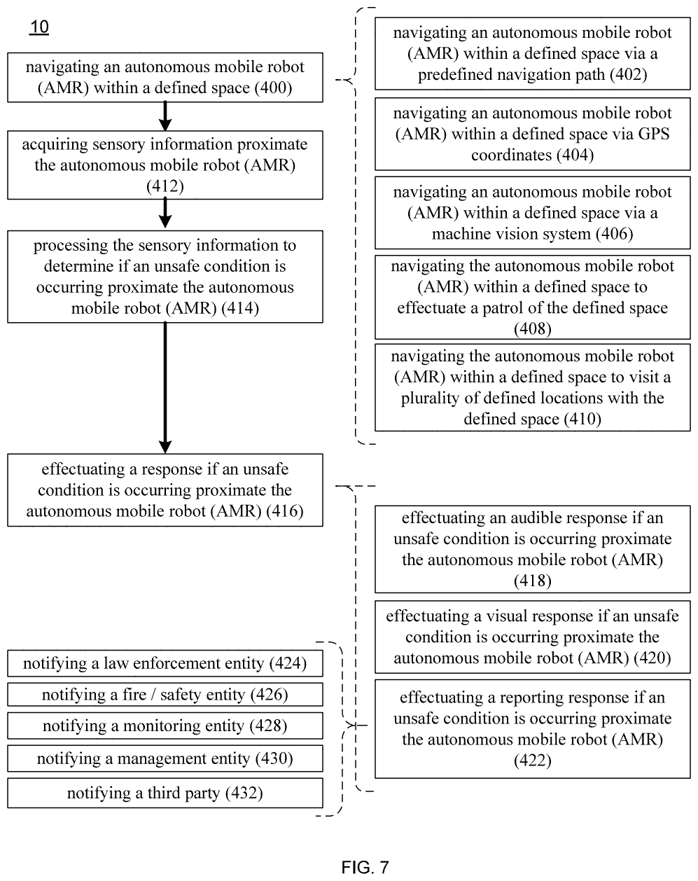

Referring also to FIG. 7 and as will be discussed below in greater detail, autonomous mobile robot process 10 may enable autonomous mobile robot (AMR) 100 to perform safety monitoring functionality within a defined space (e.g., defined space 102).

As discussed above, autonomous mobile robot process 10 may navigate 400 an autonomous mobile robot (AMR) 100 within a defined space (e.g., defined space 102), an example of which may include but is not limited to a construction site. As also discussed above, when navigating 400 an autonomous mobile robot (AMR) 100 within a defined space (e.g., defined space 102), autonomous mobile robot process 10 may:
navigate 402 an autonomous mobile robot (AMR) 100 within a defined space (e.g., defined space 102) via a predefined navigation path (e.g., predefined navigation path 112);
navigate 404 an autonomous mobile robot (AMR) 100 within a defined space (e.g., defined space 102) via GPS coordinates; and/or navigate 406 an autonomous mobile robot (AMR) 100 within a defined space (e.g., defined space 102) via a machine vision system (e.g., navigation subsystem 106), which may include various components/systems such as: a LIDAR system; a RADAR system, one or more discrete machine vision cameras, one or more thermal imaging cameras, one or more laser range finders, etc.

When navigating 400 an autonomous mobile robot (AMR) 100 within a defined space (e.g., defined space 102), autonomous mobile robot process 10 may:
navigate 408 the autonomous mobile robot (AMR) within a defined space 424 (e.g., along navigation path 112) of the defined space (e.g., defined space 102); and/or
navigate 410 the autonomous mobile robot (AMR) within a defined space (e.g., defined space 102) to visit a plurality of defined locations (e.g., locations 118, 120, 122, 124, 126, 128, 130) with the defined space (e.g., defined space 102).

As discussed above, the plurality of defined locations (e.g., locations 118, 120, 122, 124, 126, 128, 130) may include at least one human defined location and/or at least one machine defined location.

As autonomous mobile robot (AMR) 100 patrols defined space 102 and/or visits the plurality of defined locations (e.g., locations 118, 120, 122, 124, 126, 128, 130) within defined space 102, autonomous mobile robot process 10 may acquire 412 sensory information (e.g., sensory information 152) proximate the autonomous mobile robot (AMR) 100, wherein autonomous mobile robot process 10 may process 414 the sensory information (e.g., sensory information 152) to determine if an unsafe condition is occurring proximate the autonomous mobile robot (AMR) 100.

Examples of such unsafe conditions occurring proximate the autonomous mobile robot (AMR) 100 may include but are not limited to:
indications of a fire (e.g., via a thermal sensor (not shown) included within sensor system 154 or a machine vision system (not shown) included within vision system 132);
indications of a flood (e.g., via a moisture sensor (not shown) included within sensor system 154 or a machine vision system (not shown) included within vision system 132);
indications of theft (e.g., via a machine vision system (not shown) included within vision system 132);
indications of burglary (e.g., via a machine vision system (not shown) included within vision system 132);
indications of vandalism (e.g., via a machine vision system (not shown) included within vision system 132);
indications of explosion hazards (e.g., via a gas leak detector (not shown), a VOC detector (not shown), or an explosive compound detector (not shown) included within sensor system 154);
indications of excessive noise levels (e.g., via an audio sensor (not shown) included within sensor system 154);
indications of excessive pollution levels (e.g., via a VOC detector (not shown), an ozone detector (not shown), or a pollution detector (not shown) included within sensor system 154);
indications of a lack of use of personal safety equipment, such as:
   i. inadequate use of hardhats (e.g., via a machine vision system (not shown) included within vision system 132),
   ii. inadequate use of hearing protection (e.g., via a machine vision system (not shown) included within vision system 132), and
   iii. inadequate use of eye protection (e.g., via a machine vision system (not shown) included within vision system 132);
indications of a lack of use of site safety equipment, such as:
   i. inadequate use of fall protection equipment (e.g., via a machine vision system (not shown) included within vision system 132),
   ii. inadequate use of rebar safety caps (e.g., via a machine vision system (not shown) included within vision system 132),
   iii. inadequate deployment of fire safety equipment (e.g., via a machine vision system (not shown) included within vision system 132),
   iv. inadequate use of ventilation equipment (e.g., via a machine vision system (not shown) included within vision system 132), and
   v. inadequate use of safety tape (e.g., via a machine vision system (not shown) included within vision system 132).

Autonomous mobile robot process 10 may effectuate 416 a response if an unsafe condition is occurring proximate the autonomous mobile robot (AMR) 100.

For example and when effectuating 416 a response if an unsafe condition is occurring proximate the autonomous mobile robot (AMR), autonomous mobile robot process 10 may: effectuate 418 an audible response if an unsafe condition is occurring proximate autonomous mobile robot (AMR) 100. For example, autonomous mobile robot process 10 may sound a siren (not shown) included within autonomous mobile robot (AMR) 100 and/or play/synthesize an evacuation order.

Further and when effectuating 416 a response if an unsafe condition is occurring proximate autonomous mobile robot (AMR) 100, autonomous mobile robot process 10 may: effectuate 420 a visual response if an unsafe condition is occurring proximate the autonomous mobile robot (AMR) 100. For example, autonomous mobile robot process 10 may flash a strobe (not shown) or warning light (not shown) included on autonomous mobile robot (AMR) 100.

Additionally and when effectuating 416 a response if an unsafe condition is occurring proximate autonomous mobile robot (AMR) 100, autonomous mobile robot process 10 may: effectuate 422 a reporting response if an unsafe condition is occurring proximate the autonomous mobile robot (AMR) 100.

When effectuating 422 a reporting response if an unsafe condition is occurring proximate autonomous mobile robot (AMR) 100, autonomous mobile robot process 10 may:
notify 424 law enforcement entity 66 (including the location of the incident);
notify 426 fire/safety entity 68 (including the location of the incident);
notify 428 monitoring entity 70 (including the location of the incident);
notify 430 management entity 72 (including the location of the incident); and/or notify 432 third party 74 (including the location of the incident).

For example and in response to an unsafe condition that can be life threatening (e.g., fire/flood/explosion hazard), autonomous mobile robot process 10 may:
effectuate 418 an audible response by rendering an audible alarm (e.g., telling people to calmly evacuate the area),
effectuate 420 a visual response by rendering a visual alarm,
notify 424 law enforcement entity 66 (including the location of the incident),
notify 426 fire/safety entity 68 (including the location of the incident).
notify 428 monitoring entity 70 (including the location of the incident), and/or
notify 432 management entity 72 (including the location of the incident).

Further and in response to an unsafe condition concerning a safety violation, autonomous mobile robot process 10 may:
effectuate 418 an audible response by rendering an audible warning (e.g., asking people to utilize their personal protective equipment),
notify 428 monitoring entity 70 (including the location of the incident), and/or
notify 432 management entity 72 (including the location of the incident).

Further and in response to an unsafe condition concerning a property issue (e.g., theft/burglary/vandalism), autonomous mobile robot process 10 may:
effectuate 418 an audible response by rendering an audible warning (e.g., a siren),
notify 424 law enforcement entity 66 (including the location of the incident),
notify 428 a central monitoring station (including the location of the incident), and/or
notify 432 management entity 72 (including the location of the incident).

Garbage Monitoring

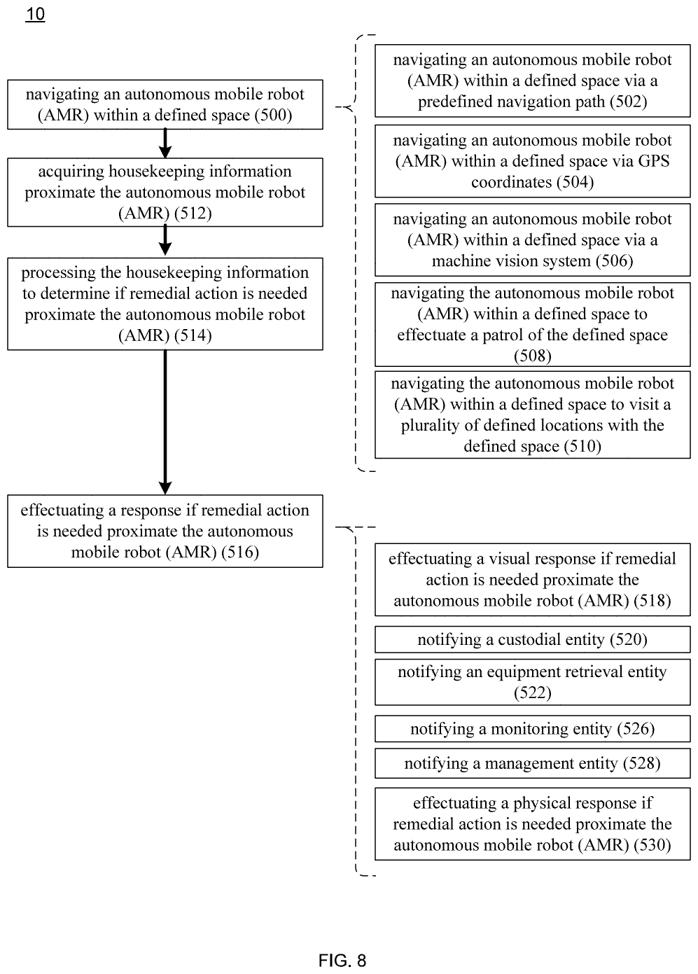

Referring also to FIG. 8 and as will be discussed below in greater detail, autonomous mobile robot process 10 may enable autonomous mobile robot (AMR) 100 to perform garbage monitoring functionality within a defined space (e.g., defined space 102).

As discussed above, autonomous mobile robot process 10 may navigate 500 an autonomous mobile robot (AMR) 100 within a defined space (e.g., defined space 102), an example of which may include but is not limited to a construction site. As also discussed above, when navigating 300 an autonomous mobile robot (AMR) 100 within a defined space (e.g., defined space 102), autonomous mobile robot process 10 may:
navigate 502 an autonomous mobile robot (AMR) 100 within a defined space (e.g., defined space 102) via a predefined navigation path (e.g., predefined navigation path 112);
navigate 504 an autonomous mobile robot (AMR) 100 within a defined space (e.g., defined space 102) via GPS coordinates; and/or
navigate 506 an autonomous mobile robot (AMR) 100 within a defined space (e.g., defined space 102) via a machine vision system (e.g., navigation subsystem 106), which may include various components/systems such as: a LIDAR system; a RADAR system, one or more discrete machine vision cameras, one or more thermal imaging cameras, one or more laser range finders, etc.

As also discussed above, when navigating 500 an autonomous mobile robot (AMR) 100 within a defined space (e.g., defined space 102), autonomous mobile robot process 10 may:
navigate 508 the autonomous mobile robot (AMR) within a defined space (e.g., defined space 102) to effectuate a patrol (e.g., along predefined navigation path 112) of the defined space (e.g., defined space 102); and/or
navigate 510 the autonomous mobile robot (AMR) within a defined space (e.g., defined space 102) to visit a plurality of defined locations (e.g., locations 118, 120, 122, 124, 126, 128, 130) with the defined space (e.g., defined space 102).

As discussed above, the plurality of defined locations (e.g., locations 118, 120, 122, 124, 126, 128, 130) may include at least one human defined location and/or at least one machine defined location.

As autonomous mobile robot (AMR) 100 patrols defined space 102 and/or visits the plurality of defined locations (e.g., locations 118, 120, 122, 124, 126, 128, 130) within defined space 102, autonomous mobile robot process 10 may acquire 512 housekeeping information (e.g., housekeeping information 156) proximate autonomous mobile robot (AMR) 100 and may process 514 the housekeeping information (e.g., housekeeping information 156) to determine if remedial action is needed proximate autonomous mobile robot (AMR) 100.

Examples of such remedial action needed may include but are not limited to one or more of:
debris that needs to be cleaned up;
a spill that needs to cleaned up;
tools/equipment that needs to be recovered/stored; and
a trash receptacle that needs to be emptied.

Autonomous mobile robot process 10 may effectuate 516 a response if remedial action is needed proximate autonomous mobile robot (AMR) 100.

For example and when effectuating 516 a response if remedial action is needed proximate autonomous mobile robot (AMR) 100, autonomous mobile robot process 10 may: effectuate 518 a visual response if remedial action is needed proximate autonomous mobile robot (AMR) 100. For example, autonomous mobile robot process 10 may sound a siren (not shown) included within autonomous mobile robot (AMR) 100 and/or play/synthesize a warning signal

Further and when effectuating 516 a response if remedial action is needed proximate autonomous mobile robot (AMR) 100, autonomous mobile robot process 10 may:
notify 520 custodial entity 76;
notify 522 equipment retrieval entity 78;
notify 524 repair/maintenance entity 80;
notify 526 monitoring entity 70; and
notify 528 management entity 72.

For example and in response to remedial action being needed concerning a cleaning issue (e.g., litter on the floor/ground, a water spill, a stain on a wall) proximate autonomous mobile robot (AMR) 100, autonomous mobile robot process 10 may:
notify 520 custodial entity 76 (including the location of the incident),
notify 526 monitoring entity 70 (including the location of the incident), and/or
notify 528 management entity 72 (including the location of the incident).

For example and in response to remedial action being needed concerning a storage/retrieval issue (e.g., tools/specialty equipment that needs to be put away) proximate autonomous mobile robot (AMR) 100, autonomous mobile robot process 10 may:
notify 522 equipment retrieval entity 78 (including the location of the incident),
notify 526 monitoring entity 70 (including the location of the incident), and/or
notify 528 management entity 72 (including the location of the incident).

Further and when effectuating 516 a response if remedial action is needed proximate autonomous mobile robot (AMR) 100, autonomous mobile robot process 10 may: effectuate 520 a physical response if remedial action is needed proximate autonomous mobile robot (AMR) 100. For example, autonomous mobile robot (AMR) 100 may be equipped with specific functionality (e.g., a vacuum system 158) to enable autonomous mobile robot (AMR) 100 to reply to minors housekeeping issues, such as vacuuming up minor debris (e.g., saw dust, metal filings, etc.).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer implemented method, executed on a computing device, comprising:
navigating an autonomous mobile robot (AMR) within a defined space;
acquiring sensory information proximate the autonomous mobile robot (AMR);
processing the sensory information to determine if an unsafe condition is occurring proximate the autonomous mobile robot (AMR); and
effectuating a response if an unsafe condition is occurring proximate the autonomous mobile robot (AMR).

2. The computer implemented method of claim 1 wherein the defined space is a construction site.

3. The computer implemented method of claim 1 wherein navigating an autonomous mobile robot (AMR) within a defined space includes one or more of:
navigating the autonomous mobile robot (AMR) within a defined space to effectuate a patrol of the defined space; and
navigating the autonomous mobile robot (AMR) within a defined space to visit a plurality of defined locations with the defined space.

4. The computer implemented method of claim 3 wherein the plurality of defined locations include one or more of:
at least one human defined location; and
at least one machine defined location.

5. The computer implemented method of claim 1 wherein navigating an autonomous mobile robot (AMR) within a defined space includes one or more of:
navigating an autonomous mobile robot (AMR) within a defined space via a predefined navigation path;
navigating an autonomous mobile robot (AMR) within a defined space via GPS coordinates; and
navigating an autonomous mobile robot (AMR) within a defined space via a machine vision system.

6. The computer implemented method of claim 4 wherein the machine vision system includes one or more of:
a LIDAR system; and
a plurality of discrete machine vision cameras.

7. The computer implemented method of claim 1 wherein effectuating a response if an unsafe condition is occurring proximate the autonomous mobile robot (AMR) includes:
effectuating an audible response if an unsafe condition is occurring proximate the autonomous mobile robot (AMR).

8. The computer implemented method of claim 1 wherein effectuating a response if an unsafe condition is occurring proximate the autonomous mobile robot (AMR) includes:
effectuating a visual response if an unsafe condition is occurring proximate the autonomous mobile robot (AMR).

9. The computer implemented method of claim 1 wherein effectuating a response if an unsafe condition is occurring proximate the autonomous mobile robot (AMR) includes:
effectuating a reporting response if an unsafe condition is occurring proximate the autonomous mobile robot (AMR).

10. The computer implemented method of claim 1 wherein effectuating a reporting response if an unsafe condition is occurring proximate the autonomous mobile robot (AMR) includes one or more of:
notifying a law enforcement entity;
notifying a fire/safety entity;
notifying a monitoring entity;
notifying a management entity; and
notifying a third party.

11. A computer program product residing on a computer readable medium having a plurality of instructions stored thereon which, when executed by a processor, cause the processor to perform operations comprising:
navigating an autonomous mobile robot (AMR) within a defined space;
acquiring sensory information proximate the autonomous mobile robot (AMR);
processing the sensory information to determine if an unsafe condition is occurring proximate the autonomous mobile robot (AMR); and
effectuating a response if an unsafe condition is occurring proximate the autonomous mobile robot (AMR).

12. The computer implemented method of claim 11 wherein the defined space is a construction site.

13. The computer implemented method of claim 11 wherein navigating an autonomous mobile robot (AMR) within a defined space includes one or more of:
navigating the autonomous mobile robot (AMR) within a defined space to effectuate a patrol of the defined space; and
navigating the autonomous mobile robot (AMR) within a defined space to visit a plurality of defined locations with the defined space.

14. The computer implemented method of claim 13 wherein the plurality of defined locations include one or more of:
at least one human defined location; and
at least one machine defined location.

15. The computer implemented method of claim 11 wherein navigating an autonomous mobile robot (AMR) within a defined space includes one or more of:
navigating an autonomous mobile robot (AMR) within a defined space via a predefined navigation path;
navigating an autonomous mobile robot (AMR) within a defined space via GPS coordinates; and
navigating an autonomous mobile robot (AMR) within a defined space via a machine vision system.

16. The computer implemented method of claim 14 wherein the machine vision system includes one or more of:
a LIDAR system; and
a plurality of discrete machine vision cameras.

17. The computer implemented method of claim 11 wherein effectuating a response if an unsafe condition is occurring proximate the autonomous mobile robot (AMR) includes:
effectuating an audible response if an unsafe condition is occurring proximate the autonomous mobile robot (AMR).

18. The computer implemented method of claim 11 wherein effectuating a response if an unsafe condition is occurring proximate the autonomous mobile robot (AMR) includes:
effectuating a visual response if an unsafe condition is occurring proximate the autonomous mobile robot (AMR).

19. The computer implemented method of claim 11 wherein effectuating a response if an unsafe condition is occurring proximate the autonomous mobile robot (AMR) includes:
effectuating a reporting response if an unsafe condition is occurring proximate the autonomous mobile robot (AMR).

20. The computer implemented method of claim 11 wherein effectuating a reporting response if an unsafe condition is occurring proximate the autonomous mobile robot (AMR) includes one or more of:
notifying a law enforcement entity;
notifying a fire/safety entity;
notifying a monitoring entity;
notifying a management entity; and
notifying a third party.

21. A computing system including a processor and memory configured to perform operations comprising:
navigating an autonomous mobile robot (AMR) within a defined space;
acquiring sensory information proximate the autonomous mobile robot (AMR);
processing the sensory information to determine if an unsafe condition is occurring proximate the autonomous mobile robot (AMR); and
effectuating a response if an unsafe condition is occurring proximate the autonomous mobile robot (AMR).

22. The computer program product of claim 21 wherein the defined space is a construction site.

23. The computer program product of claim 21 wherein navigating an autonomous mobile robot (AMR) within a defined space includes one or more of:
navigating the autonomous mobile robot (AMR) within a defined space to effectuate a patrol of the defined space; and
navigating the autonomous mobile robot (AMR) within a defined space to visit a plurality of defined locations with the defined space.

24. The computer program product of claim 23 wherein the plurality of defined locations include one or more of:
at least one human defined location; and
at least one machine defined location.

25. The computer program product of claim 21 wherein navigating an autonomous mobile robot (AMR) within a defined space includes one or more of:
navigating an autonomous mobile robot (AMR) within a defined space via a predefined navigation path;
navigating an autonomous mobile robot (AMR) within a defined space via GPS coordinates; and
navigating an autonomous mobile robot (AMR) within a defined space via a machine vision system.

26. The computer program product of claim 24 wherein the machine vision system includes one or more of:
a LIDAR system; and
a plurality of discrete machine vision cameras.

27. The computer program product of claim 21 wherein effectuating a response if an unsafe condition is occurring proximate the autonomous mobile robot (AMR) includes:
effectuating an audible response if an unsafe condition is occurring proximate the autonomous mobile robot (AMR).

28. The computer program product of claim 21 wherein effectuating a response if an unsafe condition is occurring proximate the autonomous mobile robot (AMR) includes:
effectuating a visual response if an unsafe condition is occurring proximate the autonomous mobile robot (AMR).

29. The computer program product of claim 21 wherein effectuating a response if an unsafe condition is occurring proximate the autonomous mobile robot (AMR) includes:
effectuating a reporting response if an unsafe condition is occurring proximate the autonomous mobile robot (AMR).

30. The computer program product of claim 21 wherein effectuating a reporting response if an unsafe condition is occurring proximate the autonomous mobile robot (AMR) includes one or more of:
notifying a law enforcement entity;
notifying a fire/safety entity;
notifying a monitoring entity;
notifying a management entity; and
notifying a third party.
